(19) United States
(12) Patent Application Publication
(10) Pub. No.: US 2016/0349388 A1
(43) Pub. Date: Dec. 1, 2016

(54) DEVICE FOR MONITORING VIBRATIONS

(71) Applicant: SHOTTRACK PTY LTD, Coffs Harbour (AU)

(72) Inventors: Stefan Michael Miller, Coffs Harbour (AU); Roy David Miller, Coffs Harbour (AU)

(21) Appl. No.: 15/114,468

(22) PCT Filed: Jan. 28, 2015
(86) PCT No.: PCT/AU2015/000044

§ 371 Date: Jul. 27, 2016

(30) Foreign Application Priority Data
Jan. 28, 2014 (AU) 2014900244

(51) Int. Cl. G01V 1/18; G01H 1/00; G01V 1/22

(52) U.S. Cl. CPC G01V 1/18; G01V 1/223; G01H 1/00

(57) ABSTRACT

A device for collecting vibration data, the device comprising: a housing that has an inner surface defining a void; a coupling arrangement for coupling the housing to a baseplate; a vibration sensor that is coupled to the coupling arrangement and is located in the void; and an electronic circuit that is located in the void and which is electrically coupled to the vibration sensor and which is arranged to receive a signal from the sensor and process the signal to create vibration data.

### FIELD

This disclosure relates to a device for monitoring vibrations, and more particularly—but by no means exclusively—a device for monitoring vibrations that result from the controlled detonation of explosives in a mining site.

### BACKGROUND

There are a broad range of industries in which it is of paramount importance to be able to collect and analyse vibration data. These industries include, for example, the mining industry and the construction industry. In the mining industry the ability to collect vibration data is important for numerous reasons including, for instance, monitoring the ground vibrations that result from controlled expositions within a mine. In the construction industry it is important to, for example, monitor vibrations that result from the operation of a tunnel boring machine. In many of the industries where vibration data is collected it is often done for regulatory reasons, but vibration data may also be collected for various non-regulatory reasons. Some of the regulatory reasons may relate to environmental reasons. For example, the Department of Natural Resources and Environment of the Victorian State Government (in Australia) have released a set of environmental guidelines that set out ground and vibration and air-blast limits for blasting in mines and quarries. Mining companies that want to comply with the relevant regulatory requirement will therefore need to carefully monitor the ground vibrations that result from mining activities such as controlled explosions.

There exists a large range of sensors and associated equipment for collecting and analysing vibration data. The problem with existing vibration monitoring sensors and equipment is that it is not well suited to the harsh environments encountered in industries such as mining and construction. When deployed in harsh environments such as that found in mining and construction, existing vibration monitoring equipment can have a high failure rate (e.g., the equipment can be easily damaged when used to monitor an explosion), can be time consuming to install, and can be relatively expensive. As such, there exists a need for an alternative vibration monitoring device that suitable for harsh environments such as those encountered in the mining and construction industries.

### SUMMARY

An embodiment of a device for collecting vibration data comprises:

a housing that has an inner surface defining a void;

a coupling arrangement for coupling the housing to a baseplate;

a vibration sensor that is coupled to the coupling arrangement and is located in the void; and

an electronic circuit that is located in the void and which is electrically coupled to the vibration sensor and which is arranged to receive a signal from the sensor and process the signal to create vibration data.

One of the advantages associated with the embodiment of the device for collecting the vibration data is that it provides an integrated device with all the components necessary to monitor and create data about vibrations. The housing facilitates the use of the device within harsh environments such as those found in the mining industry. The housing also enables the use of a lower cost vibration sensor because the housing provides a level of protection such that more expensive sensors with elaborate encasements do not need to be used. Furthermore, by having the vibration sensor coupled to the coupling arrangement the device is capable of creating accurate vibration data.

In this particular embodiment the device also comprises a battery located in the void and a battery charging arrangement located in the void and which is electrically coupled to the battery.

In the embodiment of the device the battery charging arrangement comprises an inductive coupling to allow the battery to be recharged by an inductive battery charger.

The embodiment of the device is also such that the electronic circuit comprises a radio frequency transmitter, wherein the electronic circuit is arranged to encode a radio frequency signal generated by the radio frequency transmitter with the vibration data.

By augmenting the device for collecting the vibration data with the battery, the charging arrangement with the inductive coupling and the radio frequency transmitter, the device effectively becomes completely self-contained and therefore does not require any connectors (such as data connector or a power source connector) for interfacing with external equipment such as computers for processing and recording the vibration data. The lack of connectors for interfacing to external equipment is particularly advantageous as connectors can be a frequent point of failure when subjected to the harsh environments found in, for example, mining. By eliminating connectors for external equipment the device for collecting vibration data has improved reliability.

The embodiment of the device for collecting the vibration data is also such that the electronic circuit is arranged to associate the vibration data with time related data.

Having the vibration data associated with the time related data is advantageous as it allows the temporal elements of the vibrations to be studied. For example, where the vibrations relate to the controlled detonation of an explosion in a mine the time data can be used to examine the resultant vibrations relative to time.

In the particular embodiment of the device it comprises a cover that is arranged to be removably fitted to the housing and when fitted to the housing is such that it seals the void.

The embodiment of the device for collecting the vibration data is such that the cover has a section that acts as the coupling arrangement, the section being such that it extends outwardly from a main surface of the cover, the section has an inner surface that defines a further void, the inner surface having a threaded section for receiving a correspondingly threaded member fixed to the baseplate.

The advantage provided by having the threaded section acting as the coupling arrangement is that it allows the device to be quickly deployed and fitted to the base plate.

The embodiment of the device is such that the section is located in a central region of the cover.

In the embodiment of the device the electronic circuit comprises a radio receiver for receiving a radio signal encoded with program data, the electronic circuit being arranged to process the program data and to operate according to the program data.

Being able to receive and process the program data is advantageous because it allows a user to program the device to collect the vibration data according to certain user requirements. For example, the program data can be used to cause the electronic circuit to collect the vibration data at a certain sample rate, only record data for a certain period of time or only collect the vibration data if the vibrations exceed a certain amplitude.

The embodiment of the device for collecting vibration data also has an on/off switch mounted to the housing and electrically coupled to the electronic circuit, the on/off switch being operable by a user from outside the housing.

The embodiment of the device is such that the cover has a plurality of protrusions each of which has a surface defining an aperture, wherein the apertures are arrange to receive a fixing device for securing the device to the baseplate.

### DESCRIPTION OF DRAWINGS

The embodiment of the device for collecting vibration data will now be described with reference to the accompanying drawings in which:

FIG. 1 is a top view of the exemplary embodiment of the device for collecting vibration data;

FIG. 2 is a bottom view of the exemplary embodiment of the device for collecting vibration data;

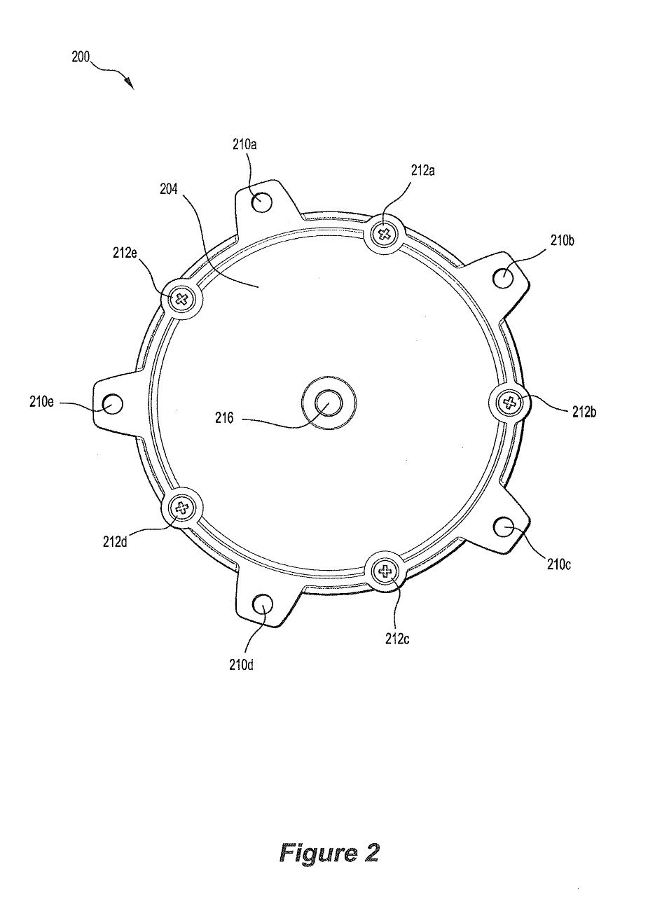

FIG. 3 is a cross-sectional side view of the exemplary embodiment of the device for collecting vibration data;

FIG. 4 is a top perspective view of the exemplary embodiment of the device for collecting vibration data;

FIG. 5 is a bottom perspective view of the exemplary embodiment of the device for collecting vibration data;

FIG. 6 is a side perspective view of the exemplary embodiment of the device for collecting vibration data;

FIG. 7 is an illustration of an electronic circuit used with the device of FIGS. 1 to 6;

FIG. 8 is a block diagram of the electronic circuit of FIG. 7; and

FIG. 9 shows the device of FIGS. 1 to 6 in relationship with a wireless battery charger.

### EMBODIMENTS

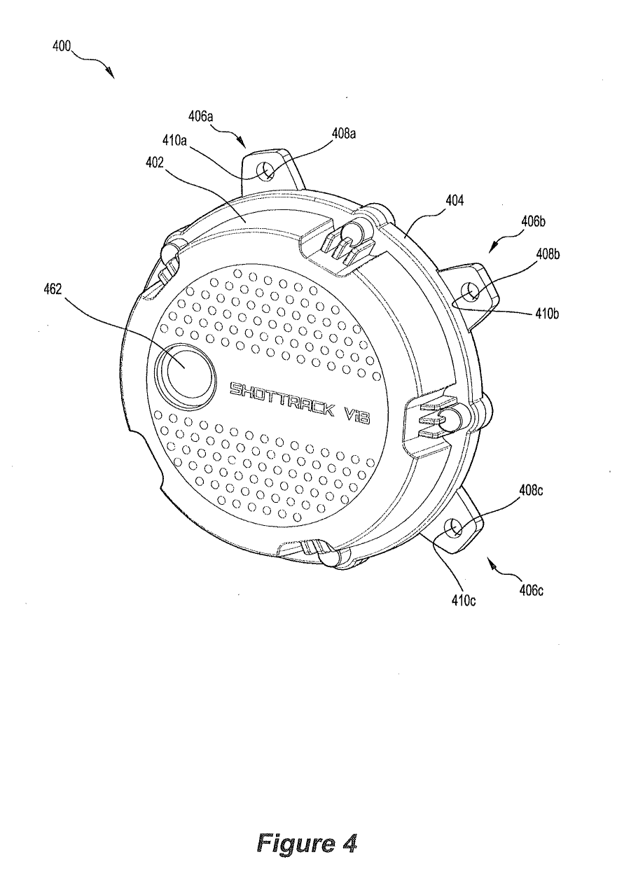

Referring to FIG. 4, a device 400 for collecting vibration data has housing 402 and a cover 404. Both the housing 402 and the cover 404 are made from nylon polyamide. Because the device 400 has a particular application to the harsh environments found in industries such as mining and construction, the housing 402 and the cover 404 are designed to comply with the ingress protection (IP) rating as defined in the international standard EN 60529. More specifically, the housing 402 and the cover 404 meet the highest ingress protection rating, IP68. By complying with IP68 the housing 402 and the cover 404 are totally dust tight and protected against prolonged effects of immersion under pressure. While in this particular embodiment of the device 400 the housing 402 and the cover 404 are made from nylon polyamide and comply with IP68, it is envisaged that the housing 402 and the cover 404 can be made from alternative materials and may (or may not) comply with other standards. As can also be seen in FIG. 4, the cover 404 has several protrusions (lugs) 406 that are evenly spaced apart and located around the outer periphery of the cover 404. The protrusions 406 are integral to the cover 404 and each have an inner surface 408 that define apertures 410. The purpose of these apertures 410 are described in subsequent sections of this specification.

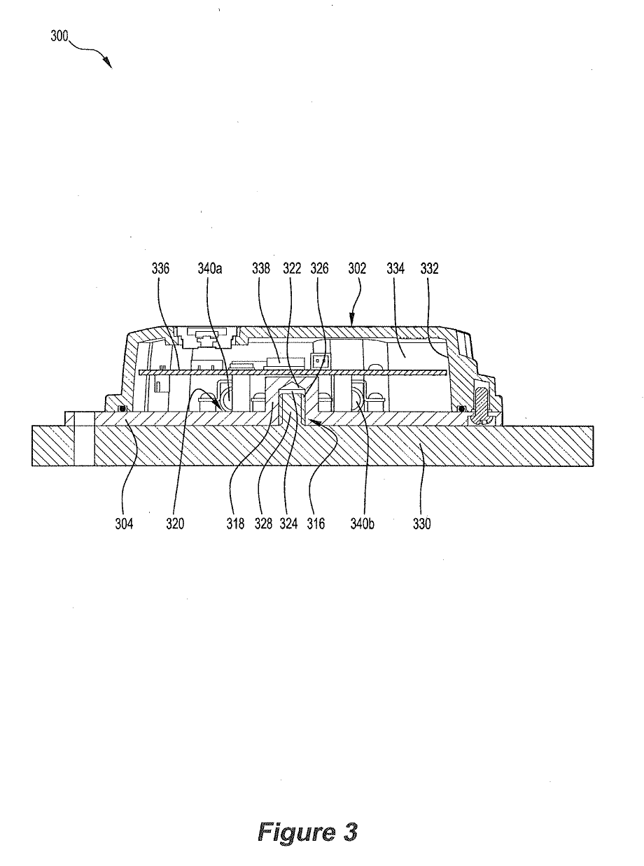

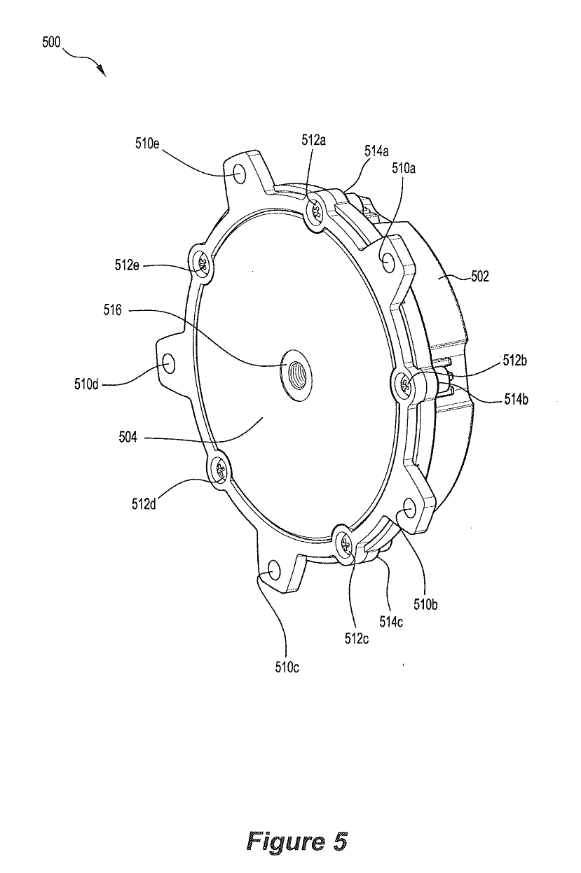

Referring now to FIG. 5, which shows a bottom perspective view of the device 500, the cover 504 is removably fitted to the housing 502. The cover 504 is fitted to the housing 504 by way of five screws 512. The screws 512 are received by threaded sections 514 that are integral parts of the housing 502. The cover 504 also has a coupling arrangement 516 located in a central region of the cover 504. As clearly illustrated in FIG. 3, the coupling arrangement 316 is formed from a section 318 of the cover 304 that extends outwardly from the surface 320 of the cover 304. The surface 320 of the cover 304 has an inner surface 322 that defines a void 324. The inner surface 322 defining the void 324 has a threaded section 326. As described in more detail in following sections of this specification, the threaded section 326 of the cover 304 is for receiving a correspondingly threaded member 328 of a baseplate 330.

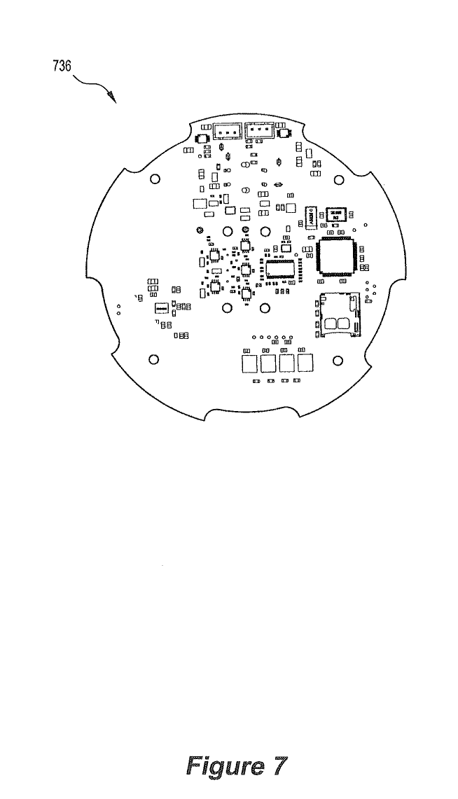

Referring again to FIG. 3, the housing 302 has an inner surface 332 that defines a void 334. Located within the void 334 is an electronic circuit 336. The electronic circuit 336 is better illustrated in FIG. 7. Also located in the void 334 of the housing 302 is a vibration sensor 338 and two rechargeable batteries 340. Referring to FIG. 5, when the cover 504 is fitted to the housing 502 the cover 504 seals off the void 334 (FIG. 3) of the housing 502 to thereby protect the sensitive electronic circuit 336, the vibration sensor 338 and the batteries 340. An important aspect of this embodiment of the device 300 is that the vibration sensor 338 is closely coupled to the coupling arrangement 316 of the cover 304. As discussed in following sections of this specification, the close coupling of the vibration sensor 338 to the coupling arrangement 316 of the cover provides for a good transfer of ground vibrations to the vibration sensor 338. If the vibration sensor 338 was only loosely coupled to the coupling arrangement 316 then inaccurate measurements of ground vibrations may result.

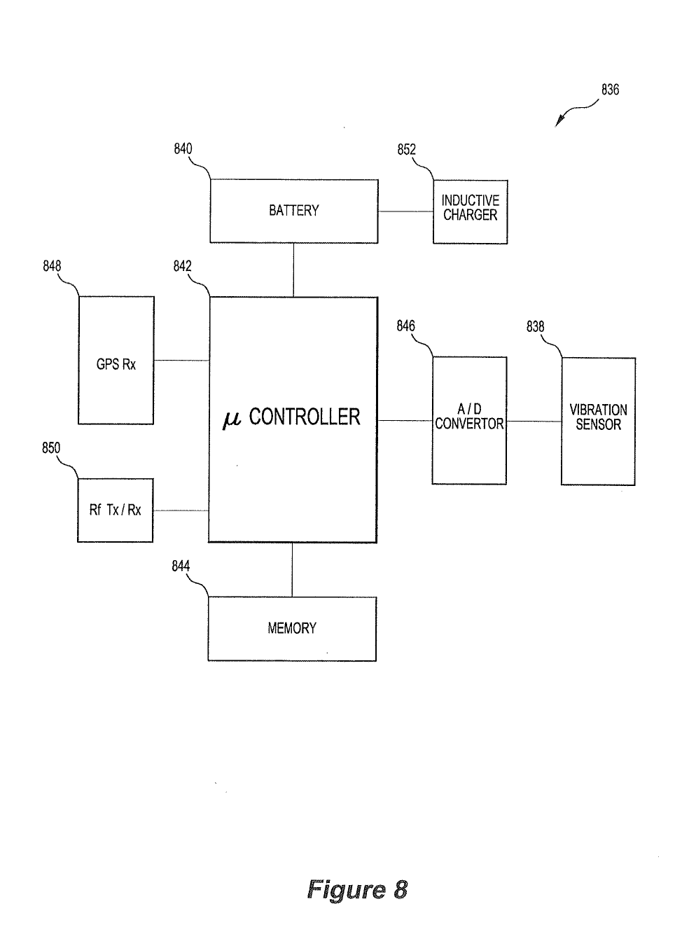

Referring to FIG. 8, which provides a block diagram of the main electronic components used in the electronic circuit 736 of FIG. 7, the electronic circuit 836 consists of several key components including: a microcontroller 842, data memory 844, an analogue to digital convertor 846, a vibration sensor 838, a global position system (GPS) receiver 848, an RF transmitter and receiver 850, rechargeable batteries 840, and an inductive battery charger 852. The microcontroller 842 is in the form of the dsPIC33EP512MU810 from Microchip, the data memory 844 is in the form of the MR20H40 from Everspin Technologies, the analogue to digital convertor 846 is in the form of the MAX11040K from Maxim, the vibration sensor 838 is in the form of the 834M1-6000 triaxial accelerometer from Measurement Specialties, the GPS receiver is in the form of the CAM-M8Q from U-Blox, the RF transmitter and receiver is in the form of the WT-41 from Bluegiga, the rechargeable batteries are in the form of PA-L2 lithium-ion batteries from Panasonic, and the inductive battery charger is in the form of the IWAS4832FFEB9R7J50 from Vishay.

As mentioned previously, the device 400 is designed to generate data about ground vibrations. In order to do this, the electronic circuit 836 is arranged to perform the following functionality. When vibrations reach the vibration sensor 838, the sensor 838 will output an analogue electrical signal. The properties of the electrical signal will vary according to the properties of the associated vibrations. The vibration sensor 838 and the analogue to digital convertor 846 are electrically connected so the electrical signals generated by the vibration sensor 838 will be received by the analogue to digital convertor 846. On receiving the electrical signal from the vibration sensor 838 the analogue to digital convertor 846 generates corresponding digital data. As the analogue electrical signal from the vibration sensor 838 changes (which occurs with changes in detected vibrations) so too does the corresponding digital data generated by the analogue to digital convertor 846. The analogue to digital convertor 846 is electrically connected with the microcontroller 842 so that the digital data generated by the analogue to digital convertor 846 is received by the microcontroller 842. On receiving the digital data from the analogue to digital convertor 846 the microcontroller 842 processes the digital data according to the way in which it has been programmed. In this regard, the microcontroller is programmed in a language (such as assembly language) to perform required functions. For example, the microcontroller 842 can be programmed to apply certain filtering algorithms to remove noise from the received digital data. Once the microcontroller 842 has processed the received digital data as required, the microcontroller 842 stores the processed data in the memory 844 for later retrieval and processing.

One of the unique functions performed by the microcontroller 842 is that it is electrically coupled to the GPS receiver 848. This enables the microcontroller 842 to retrieve a universally synchronised time signal. The GPS receiver 848 obtains the universally synchronised time signal from satellites that form part of the GPS. On receiving the synchronised time signal the microcontroller 842 associates the appropriate time signal with the relevant digital data it receives from the analogue to digital convertor 846. The advantage of having the time signal associated with the digital data is that, for instance, it is possible to accurately know when certain vibrations occurred.

As previously noted, the electrical circuit 836 includes an RF transmitter and receiver 850. The transmitter and the receiver 850 provide two important functions. First, and the device 400 is a completely sealed unit and does not have any data connectors that are accessible from outside of the device 400, it is necessary to provide a means for allowing the digital data stored in the memory 844 to be readily retrieved. It is the RF transmitter and receiver 850 that facilitates the easy retrieval of the digital data from the memory 844. More specially, the digital data in the memory 844 is obtained by using an interrogation tool, which transmits an initial RF signal requesting the digital data. In this regard, on receiving the initial RF signal the RF transmitter and receiver (which is electrically coupled to the microcontroller 842) sends the microcontroller 842 an indication that the digital data is being requested. In response to the request the microcontroller 842 retrieves the digital data from the memory 844 and sends it to the RF transmitter and receiver 850. On receiving the digital data the RF transmitter and receiver 850 encodes the data in an RF signal and transmits the encoded signal. The transmitted encoded signal is received by the interrogation tool. Once the interrogation tool has received the digital data the digital data can then be processed and analysed as required on a suitably programmed computer. The RF signal transmitted by the RF transmitter and receiver 850 is also encoded with the synchronised time signal, in additional to the digital data created as a result of the signal generated by the vibration sensor 838. In this particular embodiment of the device 400 the RF transmitter and receiver 850 is arranged to transmit an RF signal that accords with the international Bluetooth standard. However, persons skilled in the art will readily appreciate that other RF signals could be used in alternative embodiments, including mobile phone signal standards.

The other important function facilitated by the RF transmitter and receiver circuit 850 is that it allows a user to set certain operational parameters of the device 400. Most notably, using a suitable programming tool the user can set operational parameters including: the sample rate of the analogue to digital convertor 846, the length of time that the microcontroller 842 stores digital data in the memory 844, and a minimum threshold of vibration data that is to be recorded. In relation to this last parameter, the microcontroller 842 will only record digital data that corresponds to vibrations of a magnitude that are greater than a predetermined threshold. A user wishing to set the parameters to a certain value first enters the parameter values into the programming tool. Once this is complete the programming tool will transmit an RF signal that is encoded with the parameter values. On receiving this RF signal from the programming tool, the RF transmitter and receiver 850 will pass the parameter values to the microcontroller 842, which in turn will operate according to the parameter values.

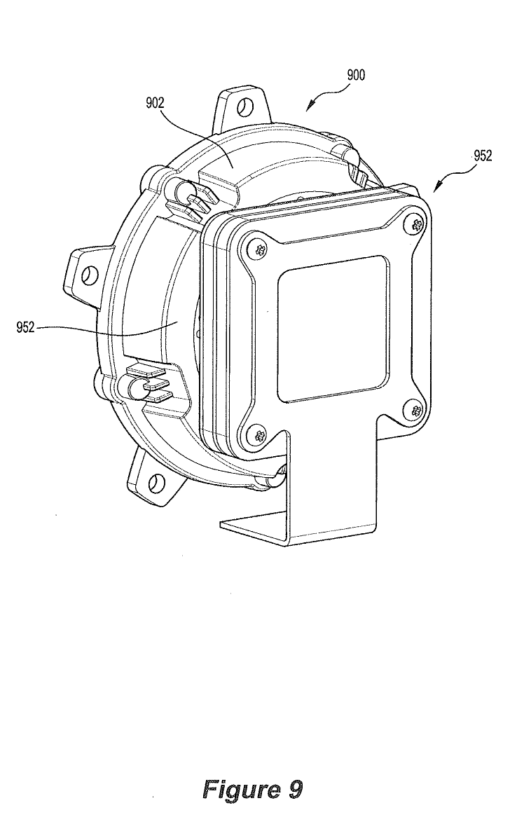

The batteries 340 provide the necessary power to allow the various electronic components of the electric circuit 836 to operate. Accordingly, the batteries are in the electrical connection with the components to allow them to function. Because the device 400 is completely sealed with no external connectors for recharging the batteries 340, the batteries 340 are recharged by the inductive charger 852. This allows a charging unit external to the device 400 to charge the batteries 840 by way off inducing the electric current in the inductive charger 852 to thereby permit wireless charging of the batteries 340. FIG. 9 shows the device 900 in operational relationship with a wireless battery charger 952. The main face 952 of the housing 902 is placed next to the charging unit 952 to permit the necessary inductive coupling between the inductive charger 852 of the electronic circuit 836 and the charging unit 952.

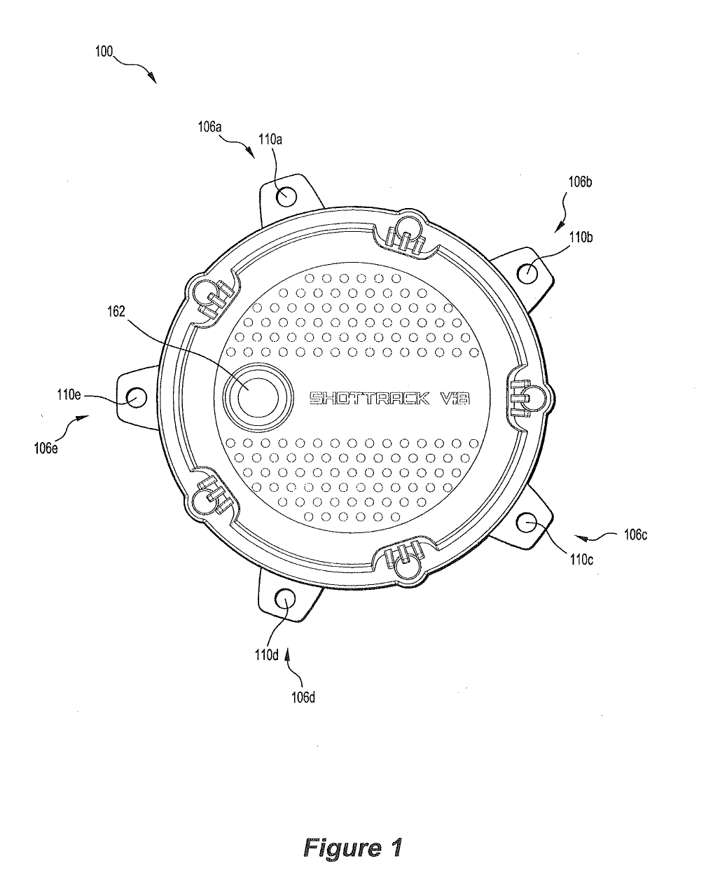

As shown in FIG. 1, the device 100 also has an on/off switch that is operable to turn the device 100 on and/or off. Accordingly, the on/off switch 160 is in electrical connection with the batteries 340 and the components of the electronic circuit 336.

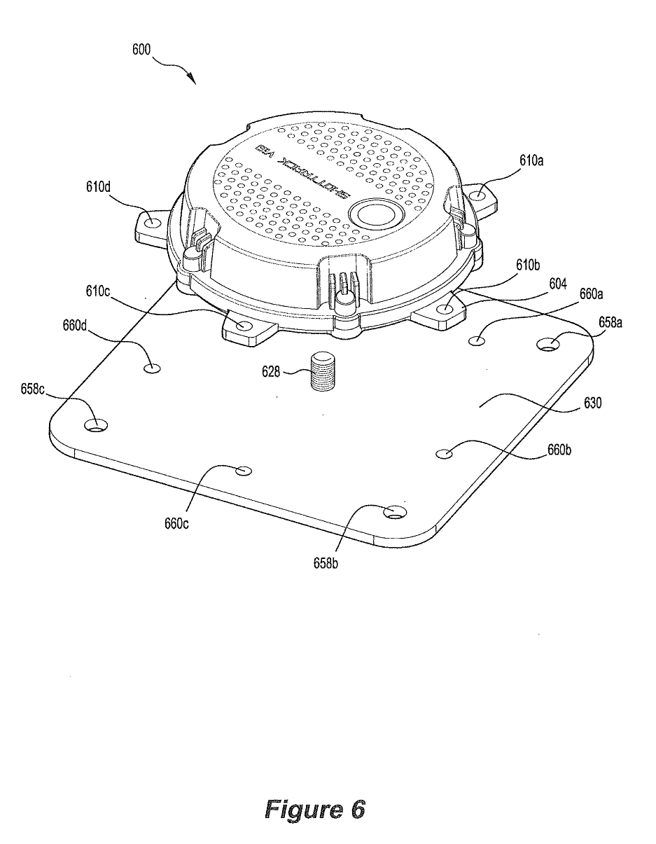

As outlined previously, the cover 404 has a threaded section 326 for allowing the device 400 to be fitted to a baseplate 330. The relationship of the device 400 and the baseplate 330 is best illustrated in FIG. 6. As can be seen in FIG. 6, the baseplate 630 has a threaded member 628. The device 600 can be quickly and easily affixed to the baseplate 630 by simply screwing the device 400 onto the threaded member 628 of the baseplate 630. The threaded member 628 is received by the threaded section 326 of the cover 604. Like the housing 602 and the cover 604 the baseplate 630 is made of nylon polyamide. The baseplate 630 has four apertures 658, each located in a corner of the baseplate 630.

In order to deploy the device 400 for use in collecting the vibration data, the user first installs the baseplate 630. This is done by securing the baseplate to a suitable object in the required location. In the case of the device 400 being used to measure vibrations from an explosion in a mining site, the baseplate 630 can be fixed to a rock near the desired blast site. Appropriate fasteners would be pasted through the apertures 658 and secured to the underlying object. Once the baseplate 630 is secured in place the device 600 can simply be screwed onto the baseplate 630 as previously described. To provide an additional level of security, the device 600 can be further secured to the baseplate 630 by passing appropriate fasteners through the apertures 610 of the cover 604 and into the corresponding apertures 660 in the baseplate 630.

With reference to FIG. 3, it is worth noting that because the vibration sensor 338 is closely coupled to the to the section 318 of the cover 304 that receives the threaded member 328 of the baseplate 330, there is minimal distortions to the vibrations that are transferred through the baseplate 330 to the threaded member 328 and then to the vibration sensor 338.

From the foregoing and with reference to the various figures, those skilled in the art will appreciate that certain modifications can also be made to the device 400 without departing from the spirit and scope of this specification. While several embodiments of the device 400 have been shown and described within this specification, it is not intended that this specification be limited thereto, as it is intended that the specification be as broad in scope as the art will allow and that the specification be read likewise. Therefore this specification should not be construed as limiting, but merely as exemplification of particular embodiments. Those skilled in the art will readily envisage other modifications with the spirit and scope of this specification.

1. A device for collecting vibration data, the device comprising:
a housing that has an inner surface defining a void;
a coupling arrangement for coupling the housing to a baseplate;
a vibration sensor that is coupled to the coupling arrangement and is located in the void; and
an electronic circuit that is located in the void and which is electrically coupled to the vibration sensor and which is arranged to receive a signal from the sensor and process the signal to create vibration data.

2. The device as claimed in claim 1 further comprising a battery located in the void and a battery charging arrangement located in the void and which is electrically coupled to the battery.

3. The device as claimed in claim 2, wherein the battery charging arrangement comprises an inductive coupling to allow the battery to be recharged by an inductive battery charger.

4. The device as claimed in claim 1, wherein the electronic circuit comprises a radio frequency transmitter and wherein the electronic circuit is arranged to encode a radio frequency signal generated by the radio frequency transmitter with the vibration data.

5. The device as claimed in claim 1, wherein the electronic circuit is arranged to associate the vibration data with time related data.

6. The device as claimed in claim 1, further comprising a cover that is arranged to be removably fitted to the housing and when fitted to the housing is such that it seals the void.

7. The device as claimed in claim 6, wherein the cover has a section that acts as the coupling arrangement, the section being such that it extends outwardly from a main surface of the cover, the section has an inner surface that defines a further void, the inner surface having a threaded section for receiving a correspondingly threaded member fixed to the baseplate.

8. The device as claimed in claim 7, wherein the section is located in a central region of the cover.

9. The device as claimed in claim 1, wherein the electronic circuit comprises a radio receiver for receiving a radio signal encoded with program data, the electronic circuit being arranged to process the program data and to operate according to the program data.

10. The device as claimed in claim 1, wherein the device further comprises and on/off switch mounted to the housing and electrically coupled to the electronic circuit, the on/off switch being operable by a user from outside the housing.

11. The device as claimed in claim 6, wherein the cover has a plurality of protrusions each of which has a surface defining an aperture, wherein the apertures are arrange to receive a fixing device for securing the device to the baseplate.
